(19) United States
(12) Patent Application Publication
(10) Pub. No.: US 2009/0097635 A1
(43) Pub. Date: Apr. 16, 2009

(54) METHOD AND APPARATUS FOR RESERVING A POSITION ON A QUEUE IN A SERVICE CENTER

(76) Inventors: Tamer E. Abuelsaad, Poughkeepsie, NY (US); Candice B. Gilzean, Cedar Park, TX (US)

Correspondence Address: IBM CORP (YA);C/O YEE & ASSOCIATES PC, P.O. BOX 802333, DALLAS, TX, 75380, US

(21) Appl. No.: 11/872,090

(22) Filed: Oct. 15, 2007

(51) Int. Cl. H04M 3/00

(52) U.S. Cl. 379/266.06

(57) ABSTRACT

The Service Call Reservation program reserves a location in a queue so that a caller does not have to stay on the line to keep a position in a queue. When a customer contacts a service center the Service Call Reservation program informs the customer of the expected wait time. If the customer believes that the wait period is too long, the customer will indicate that to the program, and the program will prompt the user to provide a preferred method of notification.

### FIELD OF THE INVENTION

The invention relates generally to computer data processing, and particularly to enabling a customer to reserve a position in a queue for receiving telephonic customer assistance.

### BACKGROUND OF THE INVENTION

One way businesses provide customer service is to have a customer service representative available at a toll free number to answer questions and provide information. For example, businesses that sell computers have customer service representatives available at toll or toll free numbers to assist customers in installation of hardware and software. Customers can also receive troubleshooting guidance to fix problems on the spot or to determine whether an item needs to be returned for repair or replacement. Providing good customer service over the phone contributes significantly to overall customer satisfaction, and can be instrumental in cementing customer loyalty. Because customer service representatives can only help one person at a time, when all customer service representatives are engaged with a customer, other customers calling in have to wait.

Often wait times for service calls can be quite long. The long wait times create a problem for the customer in a number of ways. The most obvious is the frustration and loss of time that could be used for other activities. In addition, customers may be calling on a phone limited to a certain number of minutes of usage, or on a cell phone with a low battery. Additionally, a person can be waiting to speak to a service representative, and be dropped from the call by accident.

A need exits for a system and method whereby a person can place a call to customer service and avoid the time spent waiting for an available customer service representative.

### SUMMARY OF THE INVENTION

The Service Call Reservation program reserves a location in a queue so that a caller does not have to stay on the line to keep a position in a queue. The user contacts a service center and the Service Call Reservation program prompts the customer to provide necessary information such as name, address, and phone number. The Service Call Reservation program then informs the customer of the expected wait time. If the customer believes that the wait period is too long, the customer will indicate that to the program, and the program will prompt the user to provide a preferred method of notification. For example, the method of notification may be email, text message, a call back from the service center, or the customer may call at the end of the expected wait time. Service Call Reservation program generates a reservation number that represents the customer's location in the queue. Each reservation number has an expiration time associated with it so that if the customer is not reached or does not contact the service center before the specified time, the reservation will become void.

### BRIEF DESCRIPTION OF DRAWINGS

FIG. 1 depicts an exemplary computer network;

FIG. 2 depicts an exemplary memory containing call queue reservation system and related applications and files;

FIG. 3 depicts a flow chart of call receiver program;

FIG. 4 depicts a flow chart of notification selector program;

FIG. 5 depicts a flow chart of queue monitor program; and

FIG. 6 depicts a flow chart of prompter program.

### DETAILED DESCRIPTION OF THE PREFERRED EMBODIMENT

The principles of the present invention are applicable to a variety of computer hardware and software configurations. The term “computer hardware” or “hardware,” as used herein, refers to any machine or apparatus that is capable of accepting, performing logic operations on, storing, or displaying data, and includes without limitation processors and memory; the term “computer software” or “software,” refers to any set of instructions operable to cause computer hardware to perform an operation. A “computer,” as that term is used herein, includes without limitation any useful combination of hardware and software, and a “computer program” or “program” includes without limitation any software operable to cause computer hardware to accept, perform logic operations on, store, or display data. A computer program may, and often is, comprised of a plurality of smaller programming units, including without limitation subroutines, modules, functions, methods, and procedures. Thus, the functions of the present invention may be distributed among a plurality of computers and computer programs. The invention is described best, though, as a single computer program that configures and enables one or more general-purpose computers to implement the novel aspects of the invention. For illustrative purposes, the inventive computer program will be referred to as the “Call Queue Reservation System.”

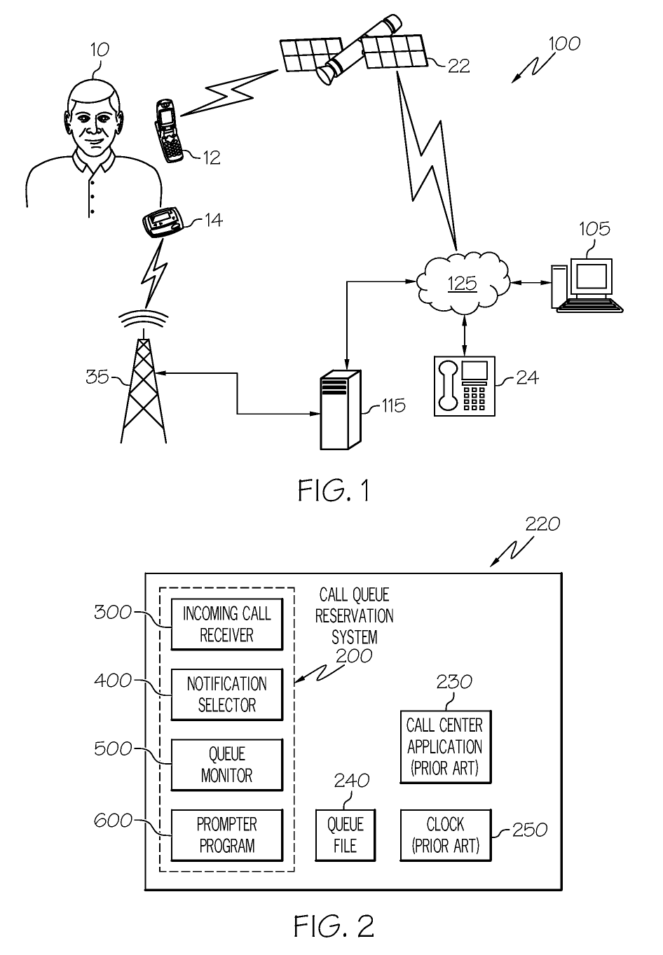

Additionally, the Call Queue Reservation System is described below with reference to an exemplary network of hardware devices, as depicted in FIG. 1. A “network” comprises any number of hardware devices coupled to and in communication with each other through a communications medium, such as the Internet. A “communications medium” includes without limitation any physical, optical, electromagnetic, or other medium through which hardware or software can transmit data. For descriptive purposes, exemplary network 100 has only a limited number of nodes, including personal communication device 12, pager 14, communications satellite 22, telephone 24, wireless transmitter 35, workstation computer 105, and server computer 115. Network connection 125 comprises all hardware, software, and communications media necessary to enable communication between network nodes 12-115. Unless otherwise indicated in context below, all network nodes use publicly available protocols or messaging services to communicate with each other through network connection 125.

Call queue reservation system 200 typically is stored in a memory, represented schematically as memory 220 in FIG. 2. The term “memory,” as used herein, includes without limitation any volatile or persistent medium, such as an electrical circuit, magnetic disk, or optical disk, in which a computer can store data or software for any duration. Thus, FIG. 2 is included merely as a descriptive expedient and does not necessarily reflect any particular physical embodiment of memory 220. Memory 220 has call queue reservation system 200 encoded therein. Call queue reservation system 200 comprises incoming call receiver 300, notification selector 400, queue monitor 500, and prompter program 600. As depicted in FIG. 2, though, memory 220 includes additional data and programs. Of particular import to call queue reservation system 200, memory 220 has queue file 240, call center application 230, and clock 250 also encoded therein.

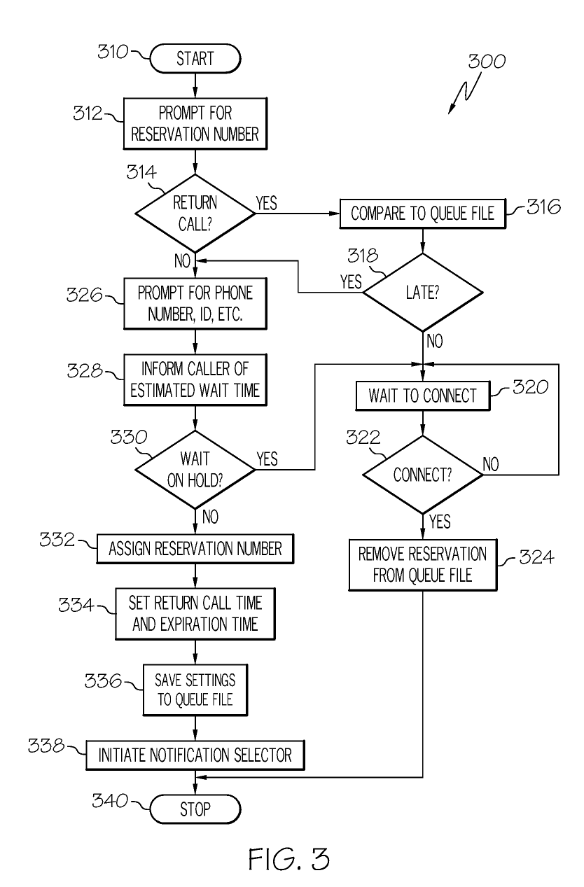

FIG. 3 depicts a flow chart of incoming call receiver program (CRP) 300. CRP 300 starts (310) and prompts the user (caller) for a reservation number (312). Next CRP 300 determines whether the call is a return call (314). If so, CRP 300 compares the call reservation number to the queue file (316), and determines whether the call is late (318). If the call is not late, then CRP 300 waits to connect the caller to customer service (320), and determines whether a connection has been made (322). If a connection has been made, CRP 300 removes the reservation from queue file (324) and stops (340).

On the other hand, if at step 314, CRP 300 determined that the call was not a return call, it prompts the user for phone number and other identification (326), informs the user of the estimated wait time (328), and determines whether the user wants to wait on hold (330). If the user wants to wait on hold, CRP 300 goes to step 320 and waits to connect the user to customer service, determines if the user is connected to customer service (322) and, when connected, removes the reservation from the queue file (324). If at step 322 a connection has not been made, CRP 300 goes to step 320 and waits.

If at step 330, the user does not want to wait on hold, CRP 300 assigns a reservation number (332), and sets a return call time and an expiration time (334). CRP 300 then saves the settings to the queue file (336), initiates notification selector (338), and stops (340).

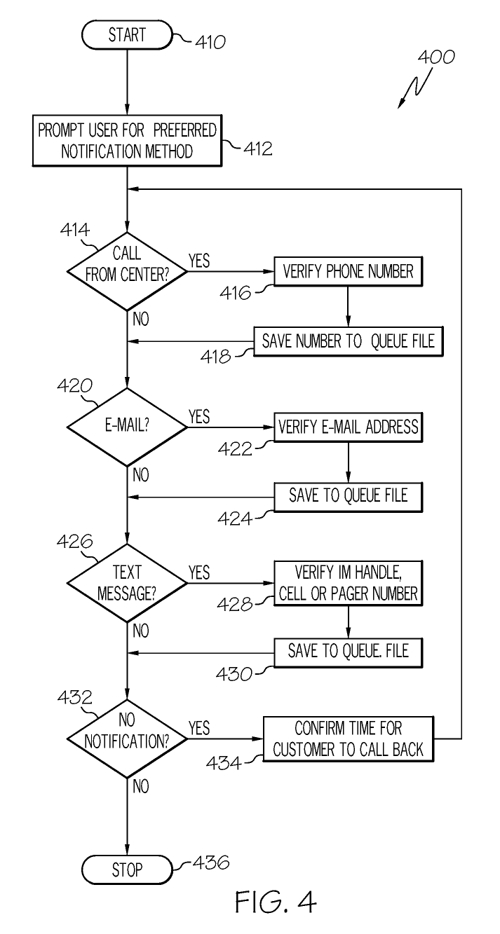

FIG. 4 depicts a flow chart of notification selector program (NSP) 400. NSP 400 starts (410) and prompts the user for a preferred notification method (412). NSP 400 then determines whether the user selected a call from the center (414). If so, NSP 400 prompts the user to verify the user's phone number (416), and saves the phone number to the queue file (418). Next NSP 400 determines whether the use selected email notification (420) and if so, prompts the user to verify the user's email address (422), and saves the email address to the queue file (424). NSP 400 then determines whether the user selected text message (426) and if so, prompts the user to verify the user's IM handle, cell or pager number (428) and saves the IM Handle, cell or page number to the queue file (430). NSP determines whether the user selected no notification (432). If no notification was selected, NSP 400 confirms the time for the customer to call back (434), and stops (436).

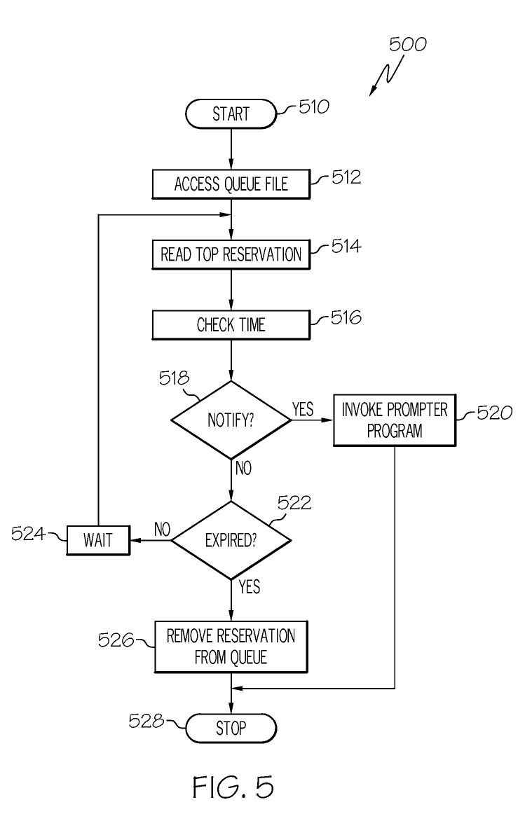

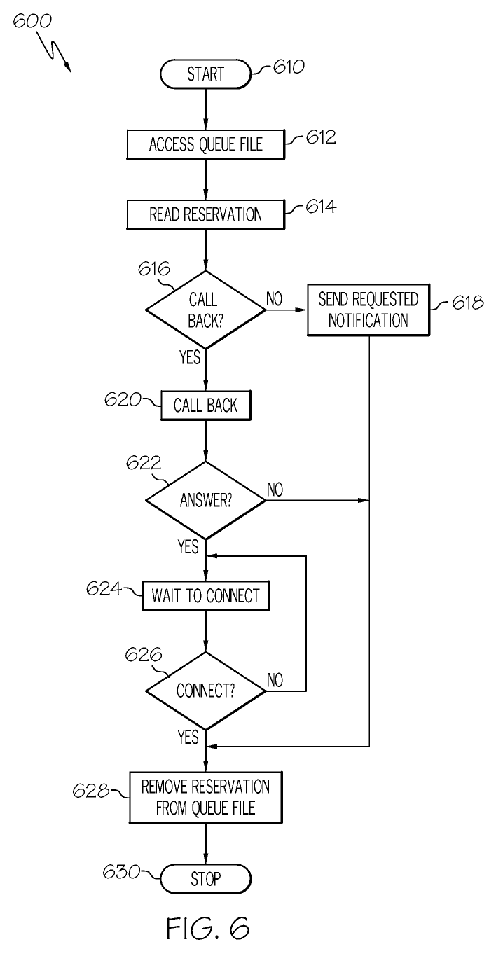

FIG. 5 depicts a flow chart of the queue monitor program (QMP) 500. QMP 500 starts (510), accesses the queue file (512), and reads the top reservation (514). QMP 500 checks the time (516) and determines whether a notification has been selected (518). If so, QMP 500 invokes prompter program 600 (520) (see FIG. 6). If not, QMP 500 determines whether the time has expired (522). If time has not expired, QMP 500 waits (524) and goes to step 514. If time has expired, QMP 500 removes the reservation from queue (526) and stops (528).

FIG. 6 depicts a flow chart of prompter program (PP) 600. PP 600 starts (610) and accesses queue file (612). PP 600 reads the reservation time (614) and determines whether a call back was selected (616). If not, PP 600 sends the requested notification (618). If so, PP 600 calls back (620) and determines whether the user answers (622). If not, PP 600 removes the reservation from queue file (628) and stops (630). If so, PP 600 waits to connect the user to customer service (624). PP 600 determines whether the use is connected (626). If not connected, PP 600 returns to step 624. If the user is connected, PP 600 removes the reservation from the queue file (628) and stops (630).

A preferred form of the invention has been shown in the drawings and described above, but variations in the preferred form will be apparent to those skilled in the art. The preceding description is for illustration purposes only, and the invention should not be construed as limited to the specific form shown and described. The scope of the invention should be limited only by the language of the following claims.

What is claimed is:

1. A computer implemented method for reserving a call back time to a customer service, the computer implemented method comprising:
prompting the user for identification and callback information;
informing the caller of the estimated wait time;
assigning a reservation number;
setting a return call time;
setting an expiration time;
saving the reservation number and the return call time to a queue file;
at the return call time, accessing the queue file and reading the reservation;
when the user calls, prompting the user for a reservation number;
comparing the reservation number to the queue file and determining whether the reservation number has expired; and
when the reservation number has not expired, connecting the user to customer service.

2. The computer implemented method of claim 1 further comprising:
when the user has been connected to customer service, confirming that a connection has been made; and
removing the reservation from the queue file.

3. The computer implemented method of claim 1 further comprising:
prompting the user to select a preferred notification method.

4. The computer implemented method of claim 3 further comprising:
when the user selects call from the center, prompting the user to verify a user's phone number, and saving the user's phone number to the queue file.

5. The computer implemented method of claim 3 further comprising:
when the user selects text message, prompting the user to verify a user's instant messaging handle, cell phone number, or pager number and saving the user's instant messaging handle, cell phone number, or pager number to the queue file.

6. The computer implemented method of claim 3 further comprising:
when the user selects no notification, confimming the time for the customer to call back.

7. The computer implemented method of claim 1 further comprising:
when a call back was selected, send a requested notification;
when the user answers, connect the user to customer service; and
remove the reservation from the queue file.

8. An apparatus for enabling a customer to reserve a position in a queue for receiving telephonic customer assistance, the apparatus comprising:
a computer having a memory
a communication system connected to the computer
a program in the memory of the computer containing instructions encoded therein to cause the computer to perform the following steps:
prompt the user for identification and callback information;
inform the caller of the estimated wait time;
assign a reservation number;
set a return call time;
set an expiration time;
save the reservation number and the return call time to a queue file;
at the return call time, access the queue file and read the reservation;
when the user calls, prompt the user for a reservation number;
compare the reservation number to the queue file and determine whether the reservation number has expired; and
when the reservation number has not expired, connect the user to customer service.

9. The apparatus of claim 8 wherein the instructions cause the computer to perform the steps of:
when the user has been connected to customer service, confirm that a connection has been made; and
remove the reservation from the queue file.

10. The apparatus of claim 8 wherein the instructions further comprise:
prompt the user to select a preferred notification method.

11. The apparatus of claim 10 wherein the instructions further comprise:
when the user selects call from the center, prompt the user to verify a user's phone number, and save the user's phone number to the queue file.

12. The apparatus of claim 10 wherein the instructions further comprise:
when the user selects text message, prompt the user to verify the user's instant messaging handle, cell phone number, or pager number and save the user's instant messaging handle, cell phone number, or pager number to the queue file.

13. The apparatus of claim 8 wherein the instructions further comprise:
when the user selects no notification, confirn the time for the customer to call back.

14. The apparatus of claim 8 wherein the instructions further comprise:
when a call back was selected, send a requested notification;
when the user answers, connect the user to customer service; and
remove the reservation from the queue file.

15. A computer readable memory containing a plurality of instructions to cause a computer to make a reservation for a customer service call, the plurality of instructions comprising:
prompting the user for identification and callback information:
informing the caller of the estimated wait time;
assigning a reservation number;
setting a return call time;
setting an expiration time;
saving the reservation number and the return call time to a queue file;
at the return call time, accessing the queue file and reading the reservation;
when the user calls, prompting the user for a reservation number;
comparing the reservation number to the queue file and determining whether the reservation number has expired; and
when the reservation number has not expired, connecting the user to customer service.

16. The computer readable memory of claim 15 wherein the plurality of instructions further comprises:
when the user has been connected to customer service, confirming that a connection has been made; and
removing the reservation from the queue file.

17. The computer readable memory of claim 15 wherein the plurality of instructions further comprises:
prompting the user to select a preferred notification method.

18. The computer readable memory of claim 15 wherein the plurality of instructions further comprises:
when the user selects call from the center, prompting the user to verify a user's phone number, and saving the user's phone number to the queue file.

19. The computer readable memory of claim 15 wherein the plurality of instructions further comprises:
when the user selects text message, prompting the user to verify the user's instant messaging handle, cell phone number, or pager number and saving the user's instant messaging handle, cell phone number, or pager number to the queue file.

20. The computer readable memory of claim 15 wherein the plurality of instructions further comprises:
when a call back was selected, send a requested notification;
when the user answers, connect the user to customer service; and
remove the reservation from the queue file.
